(19) United States
(12) Patent Application Publication
(10) Pub. No.: US 2015/0177583 A1
(43) Pub. Date: Jun. 25, 2015

(54) SYSTEMS, METHODS, AND APPARATUS FOR INTEGRATED GLASS UNITS HAVING ADJUSTABLE SOLAR HEAT GAINS

(71) Applicant: Intermolecular Inc., San Jose, CA (US)

(72) Inventors: Guowen Ding, San Jose, CA (US); Minh Huu Le, San Jose, CA (US)

(73) Assignee: Intermolecular Inc., San Jose, CA (US)

(21) Appl. No.: 14/139,441

(22) Filed: Dec. 23, 2013

(51) Int. Cl. G02F 1/153

(52) U.S. Cl. CPC G02F 1/153

(57) ABSTRACT

Disclosed herein are systems, methods, and apparatus for forming windows that may include a substrate, a bottom dielectric layer formed over the substrate, and a reflective layer formed over the bottom dielectric layer. The windows may also include a conducting barrier layer formed over the reflective layer, an electrochromic layer formed over the conducting barrier layer, and an ion conductor layer formed over the electrochromic layer. The windows may further include an ion storage layer formed over the ion conductor layer and a conducting oxide layer formed over the ion storage layer. The electrochromic layer may be configured to change a transmissivity of the windows in response to a voltage being applied to the window. The windows may have an emissivity of between about 0.01 and 0.08.

### TECHNICAL FIELD

The present disclosure relates generally to films configured to provide an adjustable solar heat gain, and more particularly to such films deposited on transparent substrates.

### BACKGROUND

Sunlight control materials, such as treated glass sheets, are commonly used for building glass windows and vehicle windows. Such materials typically offer high visible transmission and low emissivity thereby allowing more sunlight to pass through the glass window while blocking infrared (IR) radiation to reduce undesirable interior heating. In low emissivity (low-E) materials, IR radiation is mostly reflected with minimum absorption and emission, thus reducing the heat transferred to and from the low emissivity surface. Low-E panels are often formed by depositing a reflective layer (e.g., silver) onto a substrate, such as glass. The overall quality of the reflective layer is important for achieving the desired performance. In order to provide adhesion, as well as protection, several other layers are typically formed both under and over the reflective layer. These layers typically include dielectric layers, such as silicon nitride, tin oxide, and zinc oxide, which protect the stack from both the substrate and the environment. The dielectric layer may also act as optical fillers and function as anti-reflective coating layers to improve the optical characteristics of the panel.

### SUMMARY

Disclosed herein are systems, methods, and apparatus for forming windows. In some embodiments, the windows may include a substrate and a bottom dielectric layer that may be formed over the substrate. The windows may also include a reflective layer formed over the bottom dielectric layer and a conducting barrier layer formed over the reflective layer. The windows may further include an electrochromic layer formed over the conducting barrier layer and an ion conductor layer formed over the electrochromic layer. The windows may also include an ion storage layer formed over the ion conductor layer and a conducting oxide layer formed over the ion storage layer. The electrochromic layer may be configured to change a transmissivity of the windows in response to a voltage being applied to the window. Furthermore, the windows may have an emissivity of between about 0.01 and 0.08.

In some embodiments, the conducting barrier layer has a thickness of between about 8 nm to 25 nm. Moreover, according to some embodiments, the window is configured to change a solar heat gain in response to a voltage being applied to the window. The bottom dielectric layer may include zinc tin oxide and the reflective layer may include silver. In some embodiments, the conducting barrier layer may include indium tin oxide. Furthermore, the electrochromic layer may include tungsten oxide, the ion conductor layer may include lithium niobium oxide, and the ion storage layer may include niobium oxide.

In some embodiments, the windows may also include a seed layer formed between the dielectric layer and the reflective layer. The seed layer may include zinc oxide. In some embodiments, the conducting oxide layer may include a layer of indium tin oxide. Furthermore, a transmissivity of the window may be about 70%. In some embodiments, a solar heat gain of the window may be between about 60% and 75%. In some embodiments, the window is configured to change a solar heat gain from about 60% to less than 20%. Moreover, the dielectric layer may have a color that is determined based on a color of the window. Furthermore, the conducting oxide layer may have a thickness of about 150 nm.

Also disclosed herein are methods of forming a window. The methods may include providing a substrate and forming a bottom dielectric layer over the substrate. The methods may also include forming a reflective layer over the bottom dielectric layer and forming a conducting barrier layer over the reflective layer. The methods may further include forming an electrochromic layer over the conducting barrier layer and forming an ion conductor layer over the electrochromic layer. The methods may further include forming an ion storage layer over the ion conductor layer and forming a conducting oxide layer over the ion storage layer. In some embodiments, the electrochromic layer may be configured to change a transmissivity in response to a voltage being applied to the window. Furthermore, the window may have an emissivity of between about 0.01 and 0.08.

Also disclosed herein are windows that may include a substrate and a bottom dielectric layer formed over the substrate. The windows may also include a reflective layer formed over the bottom dielectric layer and a barrier layer formed over the reflective layer. The windows may further include a top dielectric layer formed over the barrier layer and a first conducting oxide layer formed over the top dielectric layer. The windows may also include an electrochromic layer formed over the first conducting oxide layer and an ion conductor layer formed over the electrochromic layer. The windows may further include an ion storage layer formed over the ion conductor layer and a second conducting oxide layer formed over the ion storage layer. The electrochromic layer may be configured to change a transmissivity in response to a voltage being applied to the window. Moreover, the windows may have an emissivity of between about 0.01 and 0.08. In some embodiments, the bottom dielectric layer may include zinc tin oxide, the reflective layer may include silver, the electrochromic layer may include tungsten oxide, the ion conductor layer may include lithium niobium oxide, and the ion storage layer may include niobium oxide. Moreover, the barrier layer may include one of nickel chromium, nickel titanium, and nickel titanium niobium, and the top dielectric layer may include one of zinc tin oxide, tin oxide, and silicon nitride.

These and other embodiments are described further below with reference to the figures.

### BRIEF DESCRIPTION OF THE DRAWINGS

To facilitate understanding, the same reference numerals have been used, where possible, to designate common components presented in the figures. The drawings are not to scale and the relative dimensions of various elements in the drawings are depicted schematically and not necessarily to scale. Various embodiments can readily be understood by considering the following detailed description in conjunction with the accompanying drawings.

FIG. 1 is a schematic illustration of a cross-section of a portion of an adjustable window that may be configured to change between two or more solar heat gains, implemented in accordance with some embodiments.

FIG. 2 is a schematic illustration of a cross-section of a portion of another adjustable window that may be configured to change between two or more solar heat gains, implemented in accordance with some embodiments.

FIG. 3 illustrates an example of a method for using an adjustable window that may be configured to change between two or more solar heat gains, implemented in accordance with some embodiments.

FIG. 4 is a process flowchart corresponding to a method of forming an adjustable window that may be configured to change between two or more solar heat gains, implemented in accordance with some embodiments.

### DETAILED DESCRIPTION OF EXAMPLE EMBODIMENTS

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

### INTRODUCTION

Conventional low emissivity windows do not provide a single glass panel that has a solar heat gain suitable for both summer and winter use. Typically, low emissivity windows may be suited for one season or the other, and may require a consumer to seasonally change windows. For example, a low emissivity window may have a single reflective layer and a relatively high solar heat gain which may be suitable for winter use. However, such a high solar heat gain might not be suitable for summer use, where a low emissivity window with two or three reflective layers and a lower solar heat gain should be used. Accordingly, a single window cannot be used for both summer and winter applications while providing a solar heat gain appropriate for both seasons.

Disclosed herein are adjustable windows which may provide the functionality of low emissivity windows while having an adjustable solar heat gain. The adjustable windows disclosed herein may have a low emissivity and high solar heat gain, thus making them suitable for winter use. Moreover, the adjustable windows may be configured to change transmissivity, for example, in the infrared region, thus changing their solar heat gain. For example, the solar heat gain of the adjustable windows may be changed to be relatively low and suitable for summer use. During winter use, the solar heat gain may be increased. Accordingly, the adjustable windows may include a stack of layers that provides both low-E and electrochromic functionalities. For example, the stack of layers may include a bottom dielectric layer, a reflective layer, a conducting barrier layer, an electrochromic layer, an ion conductor layer, an ion storage layer, and a conducting oxide layer. In contrast to conventional windows which may include electrochromic layers, the conducting barrier layer included in the adjustable windows disclosed herein may be relatively thin and absorb far less light than a conventional conducting oxide layer used in conventional electrochromic windows. Accordingly, the adjustable windows may have a low emissivity and an adjustable solar heat gain suitable for both summer and winter use.

### Examples of Integrated Glass Units

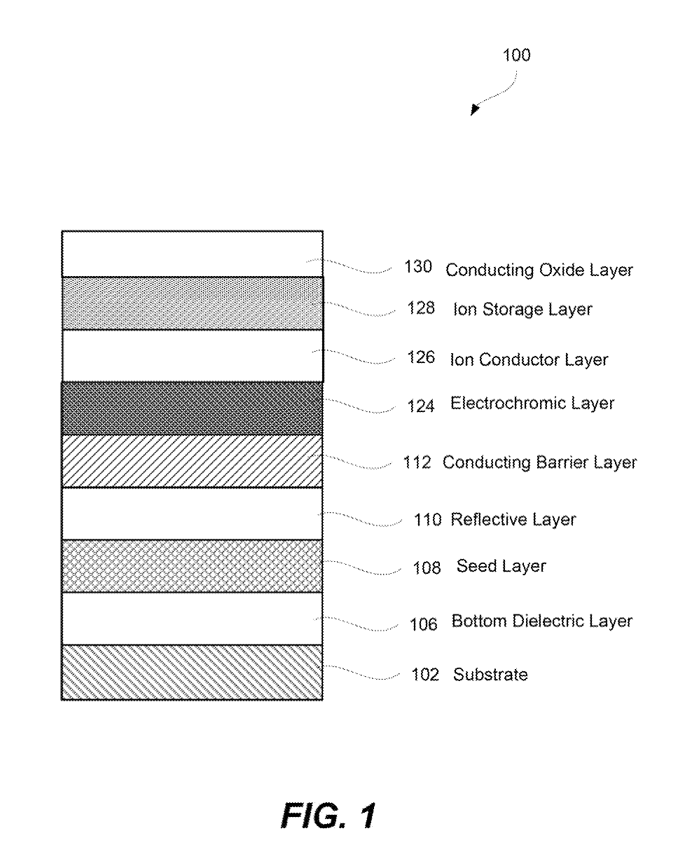

FIG. 1 is a schematic illustration of a cross-section of a portion of an adjustable window that may be configured to change between two or more solar heat gains, implemented in accordance with some embodiments. In some embodiments, an adjustable window may be a window that includes one or more layers configured to change transmissivity in response to the application of one or more voltages to the adjustable window. As discussed in greater detail below, a voltage may be applied across one or more layers within integrated glass unit (IGU) 100, which may be included in an adjustable window. The voltage may induce the migration of ions, such as lithium ions, among one or more layers within the adjustable window. A layer, such as electrochromic layer 104, may be configured to change one or more optical characteristics in response the presence or removal of ions, which may be lithium ions. For example, the migration of a high concentration of lithium ions into electrochromic layer 104 may selectively alter its transmissivity and make it less transmissive to the electromagnetic (EM) spectrum. The change in transmissivity may also include a change in an infrared transmissivity of IGU 100. In this way, a solar heat gain of an adjustable window that includes a low emissivity production coating may be adjusted in response to the application of one or more voltages to IGU 100.

Accordingly, IGU 100 may include substrate 102, which may be made of any suitable material. Substrate 102 may be opaque, translucent, or transparent to the visible light. Specifically, a transparent glass substrate may be used for this and other applications. For purposes of this disclosure, the term “transparency” is defined as a substrate characteristic related to a visible light transmittance through the substrate. The term “translucent” is defined as a property of passing the visible light through the substrate and diffusing this energy within the substrate, such that an object positioned on one side of the substrate is not visible on the other side of the substrate. The term “opaque” is defined as a visible light transmittance of 0%. Some examples of suitable materials for substrate 102 include, but are not limited to, plastic substrates, such as acrylic polymers (e.g., polyacrylates, polyalkyl methacrylates, including polymethyl methacrylates, polyethyl methacrylates, polypropyl methacrylates, and the like), polyurethanes, polycarbonates, polyalkyl terephthalates (e.g., polyethylene terephthalate (PET), polypropylene terephthalates, polybutylene terephthalates, and the like), polysiloxane containing polymers, copolymers of any monomers for preparing these, or any mixtures thereof. Substrate 102 may be also made from one or more metals, such as galvanized steel, stainless steel, and aluminum. Other examples of substrate materials include ceramics, glass, and various mixtures or combinations of any of the above.

IGU 100 may include one or more layers configured to provide a high transmissivity while also providing a low emissivity, thus enabling the transmission of visible light while minimizing the transfer of heat between an indoor and an outdoor surface of IGU 100. In some embodiments, low emissivity may refer to a quality of a surface that emits low levels of radiant thermal energy. Emissivity is the value given to materials based on the ratio of heat emitted compared to a blackbody, on a scale of 0 (for a perfect reflector) to 1 (for a black body). For example, the emissivity of a polished silver surface may be 0.01. Reflectivity is inversely related to emissivity. When values of reflectivity and emissivity are added together, their total is equal 1. In some embodiments, low emissivity coatings may be used to decrease the emissivity of IGU 100 with respect to thermal energy.

According to some embodiments, IGU 100 may include bottom dielectric layer 106 that may be used to control reflection characteristics of reflective layer 110 as well as overall transparency and color of IGU 100. Bottom dielectric layer 106 may be made of titanium oxide, zinc tin oxide, zinc oxide, tin oxide, silicon aluminum nitride, or an alloy of zinc and tin. In some embodiments, bottom dielectric layer 106 may include dopants, such as Al, Ga, In, Mg, Ca, Sr, Sb, Bi, Ti, V, Y, Zr, Nb, Hf, or Ta. The thicknesses of bottom dielectric layer 106 may be varied to optimize thermal-management performance, aesthetics, and/or durability of IGU 100. In some embodiments, bottom dielectric layer 106 may include a material that has a color that is configured or determined based on a target or desired color of IGU 100. For example, if color neutrality is desired for IGU 100, bottom dielectric layer 106 may include a material that is substantially neutral as determined by CIE LAB a*, b* coordinates and scale. In the CIE LAB color system, the “a*” value indicates the position between magenta and green (more negative values indicate stronger green and more positive values indicate stronger magenta), and the “b*” value indicates the position between yellow and blue (more negative values indicate stronger blue and more positive values indicate stronger yellow). Thus, bottom dielectric layer 106 may have a* and b* values that have absolute values that are less than 3. In some embodiments, bottom dielectric layer 106 may be configured to have a color that is opposite electrochromic layer 124 in LAB color space, thus making the overall color of IGU 100 more neutral.

In some embodiments, IGU 100 includes seed layer 108. Seed layer 108 may be formed from ZnO, SnO₂, Sc₂O₃, Y₂O₃, TiO₂, ZrO₂, HfO₂, V₂O₅, Nb₂O₅, Ta₂O₅, CrO₃, WO₃, MoO₃, various combinations thereof, or other metal oxides. The material of seed layer 108 may be in a crystalline phase (e.g. greater than 30% crystalline as determined by X-ray diffraction). Seed layer 108 may function as a nucleation template for overlying layers, e.g., reflective layer 110. In some embodiments, the thickness of seed layer 108 is between about 3 nm and 30 nm, such as about 20 nm.

IGU 100 may also include reflective layer 110, which may be formed from silver. The thickness of this layer may be between about 5 nm and 20 nm or, more specifically, between about 10 nm and 15 nm. Reflective layer 110 may have a sheet resistance of between about 6 Ohm/square and 8 Ohm/square when reflective layer 110 has a thickness between 8 nm and 9 nm. The sheet resistance of reflective layer 110 may be between about 2 Ohm/square to 4 Ohm/square for a thickness of reflective layer 110 that is between about 10 nm and 14 nm.

IGU 100 may also include conducting barrier layer 112, which may be a layer that is operable as a barrier layer for reflective layer 110, and is also operable as a conducting layer for IGU 100, as discussed in greater detail below. Accordingly, conducting barrier layer 112 may be formed over reflective layer 110 and may directly interface reflective layer 110. Conducting barrier layer 112 may protect reflective layer 110 from oxidation and other damage which may occur during the subsequent formation of other layers included in IGU 100. For example, conducting barrier layer 112 may prevent the oxidation of reflective layer 110, and also prevent the migration of one or more materials into reflective layer 110. In this way, conducting barrier layer 112 may preserve the high reflectance of reflective layer 110 and the low emissivity of IGU 100, which may be between about 0.01 and 0.08.

Moreover, conducting barrier layer 112 may be configured to be sufficiently electrically conductive to enable a voltage or electrical potential to be applied to and maintained across one or more layers included in IGU 100. As discussed in greater detail below, a voltage may be applied to conducting barrier layer 112 and conducting oxide layer 130 that may cause a change in the transmissivity of electrochromic layer 124. Accordingly, conducting barrier layer 112 may be sufficiently conductive to enable a substantially uniform distribution of the voltage applied to IGU 100 without a substantial decrease in amplitude of the voltage applied. In some embodiments, conducting barrier layer 112 has a sheet resistance that is less than about 9 Ohms/square. For example, conducting barrier layer 112 may have a sheet resistance that is about 4 Ohms/square.

In some embodiments, conducting barrier layer 112 may be configured to be relatively thin. For example, conducting barrier layer 112 may have a thickness of between about 8 nm and 25 nm, or more specifically, between about 10 nm to 15 nm. Thus, the thickness of conducting barrier layer 112 may be substantially thinner than conventional conducting oxide layers which may have a thickness that may be greater than 150 nm. The thinness of conducting barrier layer 112 enables it to be highly transmissive and maintain a high transmissivity of IGU 100, which may be upwards of about 70%. In contrast, a conventional conducting oxide layer that is relatively thick may result in poor transmission characteristics and an overall transmittance that is less than 50%. In some embodiments, conducting barrier layer 112 may be formed over one or more conductive leads configured to couple conducting barrier layer 112 to an external voltage source.

Moreover, in some embodiments, conducting barrier layer 112 may be made of a conductive metal oxide, such as indium tin oxide. Other suitable materials that may be included in conducting barrier layer 112 may include any of zinc oxide doped with aluminum, zinc oxide doped with gallium, and tin oxide doped with niobium. While various embodiments described herein include conducting barrier layer 112, in some embodiments, IGU 100 does not include conducting barrier layer 112, and reflective layer 110 may be used as a conductive layer for the purposes of changing a transmissivity of IGU 100.

In some embodiments, IGU 100 may also include one or more layers configured to change transmissivity in response to the application of one or more voltages to the adjustable window. In some embodiments, IGU 100 includes electrochromic layer 124 which may be a layer configured to adjust or change a transmissivity of at least a portion of the electromagnetic spectrum transmitted through IGU 100. In some embodiments, electrochromic layer 124 may be a layer that includes a material that is porous to one or more ions and is configured to change one or more optical characteristics in response to the presence or absence of the one or more ions. For example, a high concentration of ions may cause a decrease in optical transmissivity while a low concentration of ions may cause an increase in optical transmissivity. According to some embodiments, electrochromic layer 124 may contain one or more of a number of different materials, including metal oxides. Such metal oxides may include molybdenum oxide, niobium oxide, titanium oxide, copper oxide, iridium oxide, chromium oxide, manganese oxide, vanadium oxide, nickel oxide, tungsten oxide, and cobalt oxide.

Accordingly, in response to the application of one or more voltages to conducting barrier layer 112 and conducting oxide layer 130, discussed in greater detail below, a transmissivity of electrochromic layer 124 may be changed. For example, when transitioned to a first state, electrochromic layer 124 may include little to no lithium ions, and may be in a transmissive state which is highly transmissive. When transitioned to a second state, electrochromic layer 124 may include a high concentration of lithium ions (passed via ion conductor layer 126 discussed in greater detail below) and may be minimally transmissive.

Moreover, the adjustment of transmissivity of IGU 100 provided by electrochromic layer 124 enables the adjustment of the solar heat gain of IGU 100. When electrochromic layer 124 is in the first state, IGU 100 may have a solar heat gain that is relatively high, and is between about 50% and 100%. For example, the solar heat gain of IGU 100 when in the first state may be about 60%. Such a high solar heat gain may be suitable for winter applications where increased heat retention is desired. When electrochromic layer 124 is in the second state, IGU 100 may have a solar heat gain that is relatively low, and is less than about 20%. Such a low solar heat gain may be suitable for summer applications where increased heat retention is not desired. In this way, a single adjustable window that includes IGU 100 may be adjusted for use with both summer and winter applications.

In some embodiments, IGU 100 may include ion conductor layer 126 which may be a layer that is operable as an electrolyte and is configured to provide a medium through which ions are transported when traveling between electrochromic layer 124 and ion storage layer 128. For example, ion conductor layer 126 may be made of a material that functions as an ion conductor and provides a medium through which ions are transported in response to the application of one or more voltages to IGU 100. In some embodiments, ion conductor layer 126 may be highly conductive to the relevant ions for electrochromic layer 124 and ion storage layer 128, discussed in greater detail below. Moreover, ion conductor layer 126 may have a sufficiently low electron conductivity such that negligible electron transfer takes place during normal operation. In some embodiments, ion conductor layer 126 may be relatively thin to achieve a high ionic conductivity that permits fast ion conduction and hence fast switching of optical states. In some embodiments, ion conductor layer 126 may be made of one or more materials such silicates, silicon oxides, tungsten oxides, tantalum oxides, niobium oxides, and borates which may be doped with different dopants, such as lithium. Accordingly, ion conductor layer 126 may include lithium niobium oxide. In some embodiments, ion conductor layer 126 may be between about 5 nm to 100 nm thick.

IGU 100 may also include ion storage layer 128 which may be a layer configured to provide a reservoir for ions within IGU 100. More specifically, ion storage layer 128 may be a layer that is porous to the one or more ions associated with electrochromic layer 124. Ion storage layer 128 may be configured to store ions when electrochromic layer 124 is in a neutral state that is highly transmissive. In some embodiments, ion storage layer may be made of a metal oxide such as niobium oxide, nickel oxide, nickel tungsten oxide, nickel vanadium oxide, nickel chromium oxide, nickel aluminum oxide, nickel manganese oxide, nickel magnesium oxide, chromium oxide, manganese oxide, cerium titanium oxide, cerium zirconium oxide, nickel oxide, nickel-tungsten oxide, and vanadium oxide. In some embodiments, ion storage layer 128 is made of a material that retains a high transmittance and color neutrality even if it retains high quantities of the ions relevant to electrochromic layer 124, such as lithium. For example, if electrochromic layer 124 includes tungsten oxide, and ion conductor layer 126 includes lithium niobium oxide, ion storage layer may include niobium oxide. In this example, when electrochromic layer 124 is in or is transitioned to a neutral or bleached state, lithium ions may pass through ion conductor layer 126 and be stored in ion storage layer 128. Despite storing the lithium ions, ion storage layer 128 may retain high transmissivity and color neutrality.

IGU 100 may include conducting oxide layer 130 which may be made of any suitable material. For example, conducting oxide layer 130 may be made from one or more conductive oxides, conductive metal nitrides, and composite conductors. In some embodiments, conducting oxide layer 130 may be made of a metal oxide which may or may not be doped with one or more metals. Examples of such metal oxides and doped metal oxides include indium oxide, indium tin oxide, doped indium oxide, tin oxide, doped tin oxide, zinc oxide, aluminum zinc oxide, doped zinc oxide, ruthenium oxide, and doped ruthenium oxide. In some embodiments, conductive nitrides may also be included in conducting oxide layer 130. Examples of conductive nitrides include titanium nitrides, tantalum nitrides, titanium oxynitrides, and tantalum oxynitrides. In some embodiments, conducting oxide layer 130 may be coupled to an external voltage source via a coupler, such as a wire leg or a bus bar, which may be coupled to the edge of IGU 100 which may be included in an adjustable window.

In some embodiments, conducting oxide layer 130 may be coupled to the same external voltage source as conducting barrier layer 112. When activated, the external voltage source may establish an electric potential between conducting oxide layer 130 and conducting barrier layer 112. In this way, an electric potential or voltage may be applied to one or more layers included in IGU 100. In some embodiments, conducting oxide layer 130 may have a thickness of between about 100 nm and 500 nm. More specifically, conducting oxide layer 130 may have a thickness of 150 nm. Moreover, conducting oxide layer 130 may have a sheet resistance of about 10 Ohms per square.

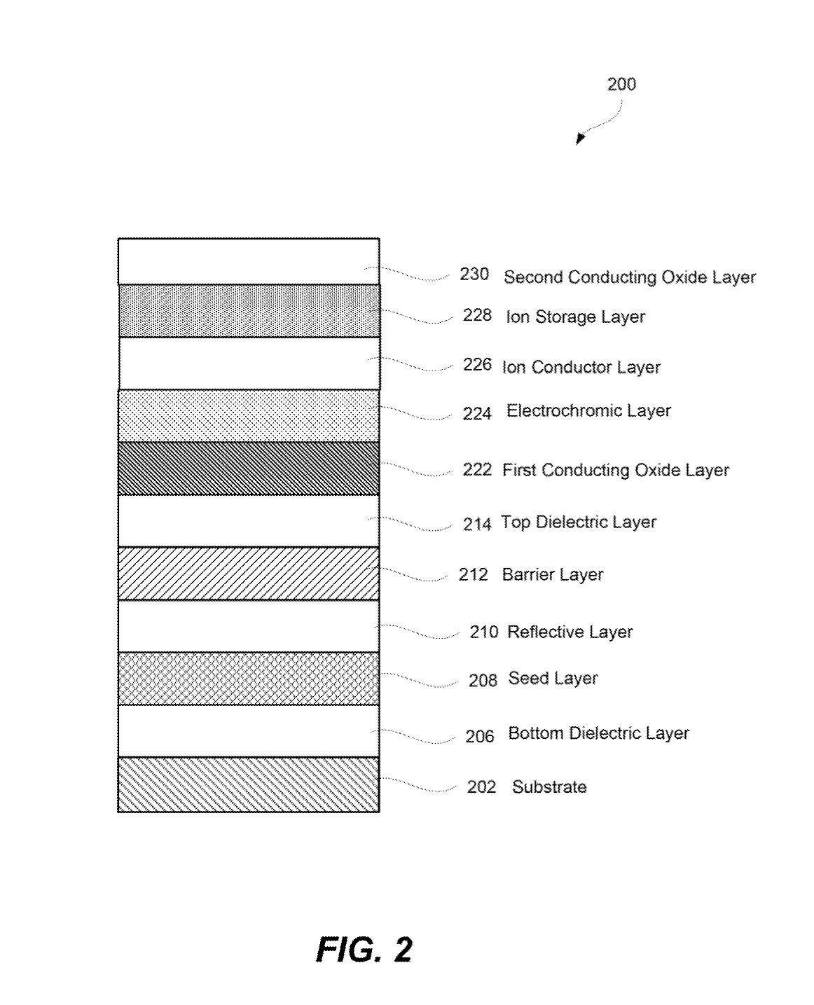

FIG. 2 is a schematic illustration of a cross-section of a portion of another adjustable window that may be configured to change between two or more solar heat gains, implemented in accordance with some embodiments. In some embodiments, integrated glass unit (IGU) 200 may include one or more layers configured to change transmissivity in response to the application of one or more voltages to the adjustable window. In this way, a solar heat gain of an adjustable window that includes a low emissivity production coating may be adjusted in response to the application of one or more voltages to IGU 200.

IGU 200 may include one or more layers configured to provide a high transmissivity while also providing a low emissivity, thus enabling the transmission of visible light while minimizing the transfer of heat between an indoor and an outdoor surface of IGU 200. Accordingly, IGU 200 may include several layers, such as reflective layer 210 which may be formed over substrate 202 and protected by a barrier layer 212. Other layers in IGU 200 may include bottom dielectric layer 206, top dielectric layer 214, and seed layer 208. As discussed above with reference to substrate 102 of FIG. 1, substrate 202 may be made of any suitable material. Some examples of suitable materials for substrate 202 may include, but are not limited to, plastic substrates, such as acrylic polymers (e.g., polyacrylates, polyalkyl methacrylates, including polymethyl methacrylates, polyethyl methacrylates, polypropyl methacrylates, and the like), polyurethanes, polycarbonates, polyalkyl terephthalates (e.g., polyethylene terephthalate (PET), polypropylene terephthalates, polybutylene terephthalates, and the like), polysiloxane containing polymers, copolymers of any monomers for preparing these, or any mixtures thereof.

IGU 200 may include dielectric layers 206 and 214 that may be used to control reflection characteristics of reflective layer 210 as well as overall transparency and color of IGU 200. Dielectric layers 206 and 214 may be made from the same or different materials and may have the same or different thickness. For example, a dielectric layer, such as dielectric layer 206 and/or dielectric layer 214, may be made of titanium oxide, zinc tin oxide, zinc oxide, tin oxide, silicon aluminum nitride, or an alloy of zinc and tin. In some embodiments, one or both dielectric layers 206 and 214 may include dopants, such as Al, Ga, In, Mg, Ca, Sr, Sb, Bi, Ti, V, Y, Zr, Nb, Hf, or Ta. Dielectric layers 206 and 214 can each include different dielectric materials with similar refractive indices or different materials with different refractive indices. The relative thicknesses of the dielectric films can be varied to optimize thermal-management performance, aesthetics, and/or durability of IGU 200. Moreover, according to some embodiments, a material included in top dielectric layer 214 may include a material that has a color that is configured or determined based on a target or desired color of IGU 200. For example, a material included in top dielectric layer 214 may be selected based on a material included in electrochromic layer 224, discussed in greater detail below. In this way, the color of electrochromic layer 224 may be matched with other layers included in IGU 200 that provide a low emissivity, and may achieve a substantially neutral color of IGU 200.

In some embodiments, IGU 200 includes seed layer 208. Seed layer 208 may be formed from ZnO, SnO₂, Sc₂O₃, Y₂O₃, TiO₂, ZrO₂, HfO₂, V₂O₅, Nb₂O₅, Ta₂O₅, CrO₃, WO₃, MoO₃, various combinations thereof, or other metal oxides. The material of seed layer 208 may be in a crystalline phase (e.g. greater than 30% crystalline as determined by X-ray diffraction). Seed layer 208 may function as a nucleation template for overlying layers, e.g., reflective layer 210. In some embodiments, the thickness of seed layer 208 is between about 3 nm and 30 nm, such as about 20 nm.

IGU 200 may also include reflective layer 210, which may be formed from silver. The thickness of this layer may be between about 5 nm and 20 nm or, more specifically, between about 10 nm and 15 nm. Reflective layer 210 may have a sheet resistance of between about 6 Ohm/square and 8 Ohm/square when reflective layer 210 has a thickness between 8 nm and 9 nm. The sheet resistance of reflective layer 210 may be between about 2 Ohm/square to 4 Ohm/square for a thickness of reflective layer 210 that is between about 10 nm and 14 nm.

IGU 200 may include barrier layer 212 to protect reflective layer 210 from oxidation and other damage. In some embodiments, barrier layer 212 may be formed from an alloy of at least nickel, titanium, and niobium. For example, barrier layer 212 may include at least one of nickel chromium, nickel titanium, and nickel titanium niobium. Moreover, barrier layer 212 may be formed from a quaternary alloy that includes nickel, chromium, titanium, and aluminum. The concentration of each metal in this alloy is selected to provide adequate transparency and oxygen diffusion blocking properties. In some embodiments, a combined concentration of nickel and chromium in the barrier layer is between about 20% by weight and 50% by weight or, more specifically, between about 30% by weight and 40% by weight. A weight ratio of nickel to chromium in the alloy may be between about 3 and 5 or, more specifically, about 4. A weight ratio of titanium to aluminum is between about 0.5 and 2, or more, specifically about 1. In some embodiments, the concentration of nickel in the barrier layer is between about 5% and 10% by weight, the concentration of chromium—between about 25% and 30% by weight, the concentration of titanium and aluminum—between about 30% and 35% by weight each. In some embodiments, nickel, chromium, titanium, and aluminum are all uniformly distributed throughout the barrier layer, i.e., its entire thickness and coverage area. Alternatively, the distribution of components may be non-uniform. For example, nickel and chromium may be more concentrated along one interface than along another interface. In some embodiments, a portion of the barrier layer near the interface with the reflective layer includes more nickel for better adhesion to the reflective layer. In some embodiments, substantially no other components other than nickel, chromium, titanium, and aluminum are present in barrier layer 212.

IGU 200 may also include one or more layers configured to adjust the transmissivity of IGU 200. For example, IGU 200 may include first conducting oxide layer 222 which may be formed on top dielectric layer 214, and electrochromic layer 224 which may be formed on first conducting oxide layer 222. IGU 200 may further include ion conductor layer 226 which may be formed on electrochromic layer 224, and ion storage layer 228 which may be formed on ion conductor layer 226. IGU 200 may also include second conducting oxide layer 230. First conducting oxide layer 222 and second conducting oxide layer 230 may include a suitable metal oxide, such as indium tin oxide. Moreover, ion conductor layer 226 may be made of lithium niobium oxide, ion storage layer 228 may be made of niobium oxide, and electrochromic layer 224 may be made of tungsten oxide.

In response to the application of one or more voltages to first conducting oxide layer 222 and second conducting oxide layer 230, a transmissivity of electrochromic layer 224 may be changed. For example, when transitioned to a first state, electrochromic layer 224 may include little to no lithium ions, and may be in a transmissive state which is highly transmissive. When transitioned to a second state, electrochromic layer 224 may include a high concentration of lithium ions and may be minimally transmissive. Accordingly, the solar heat gain of IGU 200 may be adjusted between a solar heat gain suitable for winter use and a solar heat gain suitable for summer use. For example, when electrochromic layer 224 is in the first state, IGU 200 may have a solar heat gain that is relatively high. Such a high solar heat gain may be suitable for winter applications where increased heat retention is desired. When electrochromic layer 224 is in the second state, IGU 200 may have a solar heat gain that is relatively low. Such a low solar heat gain may be suitable for summer applications where increased heat retention is not desired.

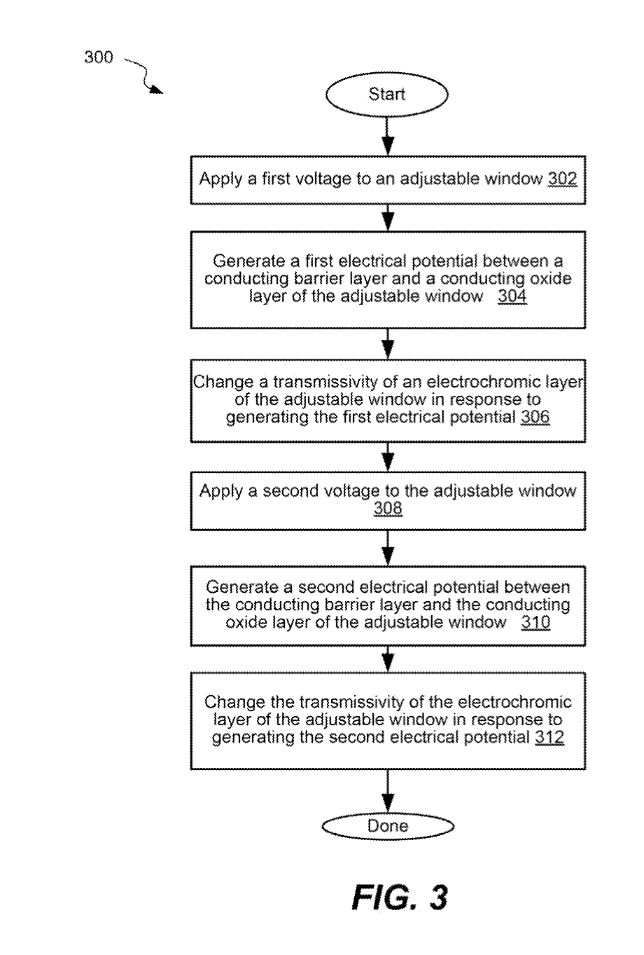

FIG. 3 illustrates an example of a method for using an adjustable window that may be configured to change between two or more solar heat gains, implemented in accordance with some embodiments. As similarly discussed above, an adjustable window may include a conducting barrier layer, an electrochromic layer, an ion conductor layer, an ion storage layer, and a conducting oxide layer. In some embodiments, method 300 may proceed by applying a first voltage to the adjustable window during operation 302. The adjustable window may be coupled to an external power source. In some embodiments, a user or an automated system may provide an input to the voltage source that causes the voltage source to provide the first voltage to the adjustable window. As discussed previously, the voltage source may be coupled to the conducting barrier layer and the conducting oxide layer.

Method 300 may proceed by generating a first electrical potential between the conducting barrier layer and the conducting oxide layer of the adjustable window during operation 304. Because the conducting barrier layer and the conducting oxide layer are both conductive and effectively spread the voltage provided by the voltage source across their respective surfaces, a first electrical potential is generated between the conducting barrier layer and the conducting oxide layer that has an amplitude substantially equal to the voltage provided by the voltage source.

Method 300 may proceed by changing a transmissivity of the electrochromic layer of the adjustable window in response to generating the first electrical potential during operation 306. In some embodiments, the first electrical potential may cause the migration of lithium ions that may be present in the electrochromic layer to migrate out of the electrochromic layer, through the ion conductor layer, and into the ion storage layer. The decrease in lithium ion concentration may cause the transmissivity of the electrochromic layer to increase.

Method 300 may proceed by applying a second voltage at the adjustable window during operation 308. Thus, to reverse the change in transmissivity, a second voltage may be applied that has an equal amplitude as the first voltage, but has an opposite polarity. The second voltage may be provided by the external power source to the conducting barrier layer and the conducting oxide layer of the adjustable window. A second electrical potential may be generated between the conducting barrier layer and the conducting oxide layer during operation 310.

Method 300 may proceed by changing the transmissivity of the electrochromic layer in response to generating the second electrical potential during operation 312. In some embodiments, the second electrical potential may cause the migration of lithium ions from the ion storage layer through the ion conductor layer and into the electrochromic layer. The increase in lithium ion concentration may cause the transmissivity of the electrochromic layer to decrease. Accordingly, changing the transmissivity of the adjustable window may change its solar heat gain from a solar heat gain that is relatively high, such as about 60%, to a solar heat gain that is relatively low, such as less than 20%, while maintaining a high emissivity.

### Processing Examples

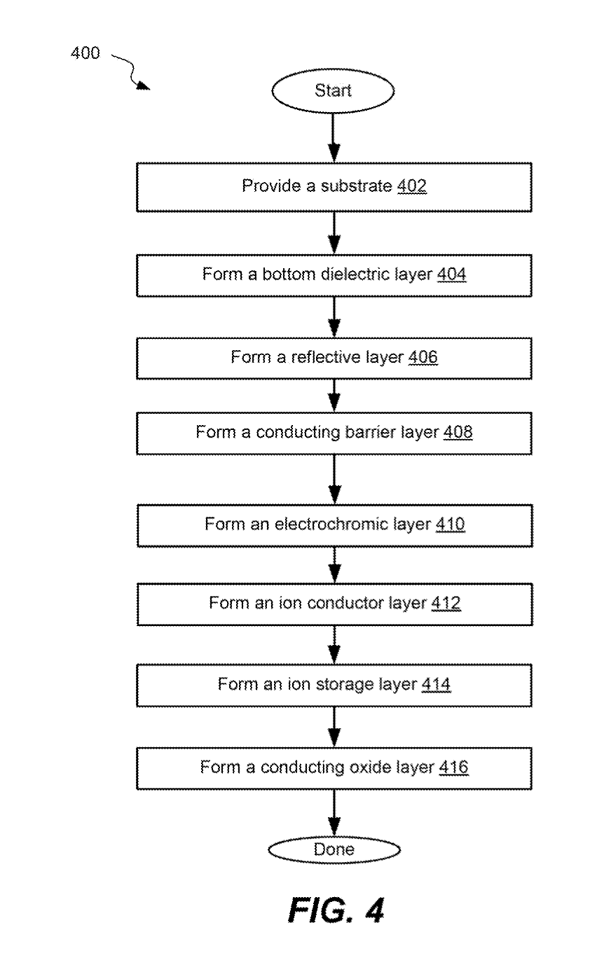

FIG. 4 is a process flowchart corresponding to a method 400 of forming an adjustable window that may be configured to change between two or more solar heat gains, implemented in accordance with some embodiments. Method 400 may commence with providing a substrate during operation 402. In some embodiments, the provided substrate is a glass substrate. Various examples of suitable substrates are described above with reference to FIG. 1.

Method 400 may proceed with forming a bottom dielectric layer during operation 404. In some embodiments, the bottom dielectric layer may be formed over the substrate. Moreover, the bottom dielectric layer may directly interface the substrate. Any suitable deposition technique may be used to form the bottom dielectric layer. For example, a physical vapor deposition technique, a chemical vapor deposition technique, or an atomic layer deposition technique may be used to form a layer of a material included in the bottom dielectric layer, such as titanium oxide, zinc tin oxide, zinc oxide, tin oxide, silicon aluminum nitride, or an alloy of zinc and tin.

Method 400 may proceed with forming a reflective layer during operation 404. This operation may involve sputtering silver in a non-reactive environment. The silver layer may be deposited in an argon environment at a pressure of 2 millitorr using 90 W power applied over a sputter area of about 12 cm² resulting in a power density of about 7500 W/m². The resulting deposition rate may be about 2.9 Angstroms per second. The target to substrate spacing may be about 240 millimeters. The thickness of the first reflective layer may be between about 50 Angstroms and 200 Angstroms.

Method 400 may proceed with forming a conducting barrier layer during operation 404. In some embodiments, the conducting barrier layer may be formed over the reflective layer. Moreover, the conducting barrier layer may directly interface the reflective layer. Any suitable deposition technique may be used to form the conducting barrier layer. For example, a physical vapor deposition technique, a chemical vapor deposition technique, or an atomic layer deposition technique may be used to form a layer of a material included in the conducting barrier layer, such as indium tin oxide. In some embodiments, the conducting barrier layer may be formed such that it partially overlaps an electrical lead, contact, or bus bar which may be coupled to a terminal of an external voltage source.

Method 400 may proceed with forming an electrochromic layer during operation 410. In some embodiments, the electrochromic layer may be formed over the conducting barrier layer. According to some embodiments, the electrochromic layer may directly interface the conducting barrier layer. Any suitable deposition technique may be used to form the electrochromic layer. For example, a physical vapor deposition technique, a chemical vapor deposition technique, or an atomic layer deposition technique may be used to form a layer of a material included in the electrochromic layer, such as tungsten oxide.

Method 400 may proceed with forming an ion conductor layer during operation 412. In some embodiments, the ion conductor layer may be formed over the electrochromic layer. Furthermore, the ion conductor layer may directly interface the electrochromic layer. As similarly discussed above, any suitable deposition technique may be used to form the ion conductor layer. For example, a physical vapor deposition technique, a chemical vapor deposition technique, or an atomic layer deposition technique may be used to form a layer of a material included in the ion conductor layer, such as lithium niobium oxide.

Method 400 may proceed with forming an ion storage layer during operation 414. In some embodiments, the ion storage layer may be formed over the ion conductor layer. Moreover, the ion storage layer may directly interface the ion conductor layer. Any suitable deposition technique may be used to form the ion storage layer. For example, a physical vapor deposition technique, a chemical vapor deposition technique, or an atomic layer deposition technique may be used to form a layer of a material included in the ion storage layer, such as niobium oxide.

Method 400 may proceed with forming a conducting oxide layer during operation 416. In some embodiments, the conducting oxide layer may be formed over the ion storage layer. Moreover, the conducting oxide layer may directly interface the ion storage layer. Any suitable deposition technique may be used to form the conducting oxide layer. For example, a physical vapor deposition technique, a chemical vapor deposition technique, or an atomic layer deposition technique may be used to form a layer of a material included in the conducting oxide layer, such as indium tin oxide. The conducting oxide layer may overlap an electrical lead, contact, or bus bar which may be coupled to an external voltage source.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

What is claimed is:

1. A window comprising:
a substrate;
a bottom dielectric layer formed over the substrate;
a reflective layer formed over the bottom dielectric layer;
a conducting barrier layer formed over the reflective layer;
an electrochromic layer formed over the conducting barrier layer;
an ion conductor layer formed over the electrochromic layer;
an ion storage layer formed over the ion conductor layer; and
a conducting oxide layer formed over the ion storage layer.

2. The window of claim 1, wherein the conducting barrier layer has a thickness of between about 8 nm to 25 nm.

3. The window of claim 1, wherein the window is configured to change a solar heat gain in response to receiving a voltage.

4. The window of claim 1, wherein the bottom dielectric layer comprises zinc tin oxide and the reflective layer comprises silver.

5. The window of claim 1, wherein the conducting barrier layer comprises indium tin oxide.

6. The window of claim 1, wherein the electrochromic layer comprises tungsten oxide, wherein the ion conductor layer comprises lithium niobium oxide, and wherein the ion storage layer comprises niobium oxide.

7. The window of claim 1 further comprising a seed layer formed between the dielectric layer and the reflective layer, the seed layer comprising zinc oxide.

8. The window of claim 1, wherein the conducting oxide layer comprises a layer of indium tin oxide.

9. The window of claim 1, wherein a transmissivity of the window is about 70%.

10. The window of claim 1, wherein a solar heat gain of the window is between about 60% and 75%.

11. The window of claim 1, wherein the window is configured to change a solar heat gain from about 60% to less than 20%.

12. The window of claim 1, wherein the dielectric layer has a color that is determined based on a color of the window.

13. The window of claim 1, wherein the conducting oxide layer has a thickness of 150 nm.

14. A method of forming a window, the method comprising:
providing a substrate;
forming a bottom dielectric layer over the substrate;
forming a reflective layer over the bottom dielectric layer;
forming a conducting barrier layer over the reflective layer;
forming an electrochromic layer over the conducting barrier layer;
forming an ion conductor layer over the electrochromic layer;
forming an ion storage layer over the ion conductor layer; and
forming a conducting oxide layer over the ion storage layer.

15. The method of claim 14, wherein the bottom dielectric layer comprises zinc tin oxide, wherein the reflective layer comprises silver, wherein the conducting barrier layer comprises indium tin oxide, wherein the electrochromic layer comprises tungsten oxide, wherein the ion conductor layer comprises lithium niobium oxide, and wherein the ion storage layer comprises niobium oxide.

16. The method of claim 14 further comprising:
applying a voltage to the window,
wherein a solar heat gain of the window changes from about 60% to less than 20% in response to the applying of the voltage.

17. The method of claim 14, wherein the conducting barrier layer has a thickness of between about 8 nm to 25 nm.

18. A window comprising:
a substrate;
a bottom dielectric layer formed over the substrate;
a reflective layer formed over the bottom dielectric layer;
a barrier layer formed over the reflective layer;
a top dielectric layer formed over the barrier layer;
a first conducting oxide layer formed over the top dielectric layer;
an electrochromic layer formed over the first conducting oxide layer;
an ion conductor layer formed over the electrochromic layer;
an ion storage layer formed over the ion conductor layer; and
a second conducting oxide layer formed over the ion storage layer.

19. The window of claim 18, wherein the bottom dielectric layer comprises zinc tin oxide, wherein the reflective layer comprises silver, wherein the electrochromic layer comprises tungsten oxide, wherein the ion conductor layer comprises lithium niobium oxide, and wherein the ion storage layer comprises niobium oxide.

20. The window of claim 18, wherein the barrier layer comprises one of nickel chromium, nickel titanium, and nickel titanium niobium, and wherein the top dielectric layer comprises one of zinc tin oxide, tin oxide, and silicon nitride.
